(19) United States
(12) Patent Application Publication
(10) Pub. No.: US 2011/0235675 A1
(43) Pub. Date: Sep. 29, 2011

(54) SUBSTRATE MOUNTING TABLE

(75) Inventors: Tatsuo Matsudo, Nirasaki (JP); Chishio Koshimizu, Nirasaki (JP)

(73) Assignee: TOKYO ELECTRON LIMITED, Tokyo (JP)

(21) Appl. No.: 13/069,568

(22) Filed: Mar. 23, 2011

Related U.S. Application Data
(60) Provisional application No. 61/325,570, filed on Apr. 19, 2010.

(30) Foreign Application Priority Data
Mar. 25, 2010 (JP) 2010-069084

(51) Int. Cl. G01J 5/08; G01J 5/02

(52) U.S. Cl. 374/130; 374/121; 374/E13.001; 374/E11.001

(57) ABSTRACT

There is provided a substrate mounting table capable of accurately measuring a temperature of a wafer supported on the substrate mounting table without incurring contamination within a chamber and without forming a hole for measuring a temperature in the substrate mounting table. The substrate mounting table includes a mounting surface 90a configured to mount a wafer W thereon; a substrate lifting unit 80 configured to lift the wafer W by a lift pin 84 from the mounting surface 90a; and a light irradiating/receiving unit 87 configured to irradiate a measurement light beam 88 as a low-coherence light beam to the wafer W through an inside of the lift pin 84 serving as an optical path and receive reflected light beams from a front surface and a rear surface of the wafer W. The light irradiating/receiving unit 87 is fixed to a base plate 86 of the substrate lifting unit 80.

### CROSS-REFERENCE TO RELATED APPLICATION

This application claims the benefit of Japanese Patent Application No. 2010-069084 filed on Mar. 25, 2010 and U.S. Provisional Application Ser. No. 61/325,570 filed on Apr. 19, 2010, the entire disclosures of which are incorporated herein by reference.

### FIELD OF THE INVENTION

The present disclosure relates to a substrate mounting table including a substrate lifting unit.

### BACKGROUND OF THE INVENTION

In a substrate processing apparatus for performing various processes such as a plasma process on various substrates such as a semiconductor wafer (hereinafter, simply referred to as “wafer”), a temperature of the wafer has been monitored to correct a temperature drift of an electrostatic chuck that holds the wafer in order to perform the process securely. By way of example, there has been suggested a technique of measuring a temperature of a wafer in a processing vessel (chamber) by a fluorescence thermometer using fluorescence (see, for example, Patent Document 1).
Patent Document 1: Japanese Patent Laid-open Publication No. 2001-358121

However, since the fluorescence thermometer has a contact type probe, heat is not transferred well under a low pressure or vacuum atmosphere, and, thus, the temperature may not be accurately measured. Further, when the wafer is coated with fluorescent paint and the temperature of the wafer is measured based on reflected light beams from the fluorescent paint, the fluorescent paint becomes a contamination source in the chamber. Furthermore, since the reflected light beams from the fluorescent paint are isotropically emitted, a through hole is additionally formed in a substrate mounting table in order to efficiently receive the reflected light beams, and a front end of light receiving fiber is led to the wafer through the through hole. In this case, however, temperature uniformity of the substrate mounting table deteriorates due to the presence of the through hole additionally formed in the substrate mounting table.

### BRIEF SUMMARY OF THE INVENTION

The present disclosure provides a substrate mounting table capable of accurately measuring a temperature of a wafer supported on the substrate mounting table without incurring contamination within a chamber and without forming a hole for measuring a temperature in the substrate mounting table.

In view of the foregoing circumstances, in accordance with one aspect of the present disclosure, there is provided a substrate mounting table including a mounting surface configured to mount a substrate thereon; a substrate lifting unit configured to lift the substrate by a lift pin from the mounting surface; and a light irradiating/receiving unit configured to irradiate a measurement light beam as a low-coherence light beam to the substrate through an inside of the lift pin serving as an optical path and receive reflected light beams from a front surface and a rear surface of the substrate.

In the substrate mounting table, the light irradiating/receiving unit may be fixed to a base plate of the substrate lifting unit and the measurement light beam may be irradiated to the substrate along a straight-line optical path.

In the substrate mounting table, the light irradiating/receiving unit may be fixed to a lift arm of the substrate lifting unit and the measurement light beam may be irradiated to the substrate along a straight-line optical path.

In the substrate mounting table, the light irradiating/receiving unit may be fixed to a base plate of the substrate lifting unit and the measurement light beam may be reflected from a prism or a mirror and irradiated to the substrate along a bent optical path.

In the substrate mounting table, the light irradiating/receiving unit may be fixed to a lift arm of the substrate lifting unit and the measurement light beam may be reflected from a prism or a mirror and irradiated to the substrate along a bent optical path.

In the substrate mounting table, the light irradiating/receiving unit may include an adjustment unit capable of adjusting an irradiation angle of the measurement light beam.

In the substrate mounting table, the light irradiating/receiving unit may be optically connected to a light receiving device as a low-coherence light optical system included in a low-coherence light interference temperature measurement system.

In the substrate mounting table, the lift pin may include a rod pin.

In the substrate mounting table, a low-coherence light beam may pass through the rod pin and both end surfaces of the rod pin may be parallel to each other and mirror-polished.

In the substrate mounting table, an area of a front end surface of the rod pin from which the measurement light beam is emitted may be parallel to the other end surface facing the front end surface.

In the substrate mounting table, the lift pin may include a hollow pin.

In accordance with the present disclosure, since fluorescent paint is not used, the inside of the chamber is not contaminated. Further, since the inside of the lift pin is used as the optical path of the low-coherence light beam, a hole for measuring a temperature need not be formed. Therefore, the temperature of the wafer supported on the substrate mounting table can be accurately measured.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is a cross-sectional view schematically showing a configuration of a substrate processing apparatus employing a substrate mounting table in accordance with an embodiment of the present disclosure;

FIG. 2 shows a schematic configuration of a substrate lifting unit provided within a chamber of FIG. 1, and specifically, FIG. 2A is a plane view of this unit when viewed from a direction of an arrow A in FIG. 1 and FIG. 2B is a cross-sectional view taken along a line B-B of FIG. 2A;

FIG. 3 is a cross-sectional view schematically showing a substrate lifting unit in accordance with an embodiment of the present disclosure;

FIG. 4 is a block diagram schematically showing a configuration of a low-coherence light interference temperature measurement system;

FIG. 5 is an explanatory diagram for describing a temperature measurement operation of a low-coherence light optical system of FIG. 4;

FIGS. 6A and 6B provide graphs each showing interference waveforms detected by a PD of FIG. 4 between reflected light beams from a temperature measurement target and a reflected light beam from a reference mirror;

FIGS. 7A to 7J provide cross-sectional views each showing an example lift pin employed in the substrate lifting unit in accordance with the present embodiment;

FIG. 8 is a cross-sectional view schematically showing a configuration of a substrate lifting unit in accordance with a first modification example;

FIG. 9 is a cross-sectional view schematically showing a configuration of a substrate lifting unit in accordance with a second modification example;

FIG. 10 is a cross-sectional view schematically showing a configuration of a substrate lifting unit in accordance with a third modification example; and

FIG. 11 is a cross-sectional view schematically showing a configuration of a substrate lifting unit in accordance with a fourth modification example.

### DETAILED DESCRIPTION OF THE INVENTION

Hereinafter, there will be explained a substrate processing apparatus employing a substrate mounting table in accordance with an embodiment of the present disclosure.

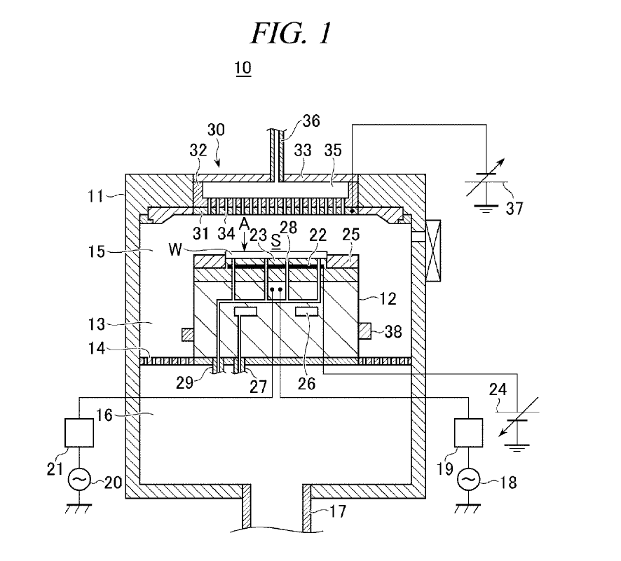

FIG. 1 is a cross-sectional view schematically showing a configuration of a substrate processing apparatus employing a substrate mounting table in accordance with the present disclosure. This substrate processing apparatus performs a plasma etching process on a wafer.

Referring to FIG. 1, a substrate processing apparatus 10 may include a chamber 11 that accommodates a wafer W, and a cylindrical susceptor 12 for mounting the wafer W thereon is positioned within the chamber 11. A side exhaust path 13 is formed by an inner wall of the chamber 11 and a side surface of the susceptor 12. An exhaust plate 14 is positioned on the way of the side exhaust path 13.

The exhaust plate 14 is a plate-shaped member having a multiple number of through holes and serves as a partition plate to partition the inside of the chamber 11 into an upper region and a lower region. In the upper region (hereinafter, referred to as “processing chamber”) 15 of the inside of the chamber 11 partitioned by the exhaust plate 14, plasma is generated as described below. Further, the lower region (hereinafter, referred to as “exhaust chamber (manifold)”) 16 of the inside of the chamber 11 is connected with an exhaust pipe 17 that exhausts a gas of the inside of the chamber 11. The exhaust plate 14 confines or reflects plasma generated in the processing chamber 15 so as to prevent a leakage of the plasma into the manifold 16.

The exhaust pipe 17 is connected with a turbo molecular pump (TMP) (not illustrated) and a dry pump (DP) (not illustrated), and these pumps exhaust the inside of the chamber 11 so as to depressurize the chamber 11 to a predetermined pressure level. Further, a pressure within the chamber 11 is controlled by an APC valve (not illustrated).

The susceptor 12 within the chamber 11 is connected with a first high frequency power supply 18 and a second high frequency power supply 20 via a first matching unit 19 and a second matching unit 21, respectively. The first high frequency power supply 18 applies a high frequency power (bias power) having a relatively low frequency of, e.g., about 2 MHz to the susceptor 12 and the second high frequency power supply 20 applies a high frequency power (plasma generation power) having a relatively high frequency of, e.g., about 60 MHz to the susceptor 12. Thus, the susceptor 12 serves as an electrode. Further, the first matching unit 19 and the second matching unit 21 reduce reflection of the high frequency powers from the susceptor and maximize application efficiencies of the high frequency powers to the susceptor 12.

Provided on the susceptor 12 is an electrostatic chuck 23 in which an electrostatic electrode plate 22 is embedded. The electrostatic chuck 23 has a stepped portion and is made of ceramic.

The electrostatic electrode plate 22 is connected with a DC power supply 24. If a positive DC voltage is applied to the electrostatic electrode plate 22, a negative potential is generated on a surface (hereinafter, referred to as “rear surface”) of the wafer W on the side of the electrostatic chuck 23 and then an electric field is generated between the electrostatic electrode plate 22 and the rear surface of the wafer W. The wafer W is attracted to and held on the electrostatic chuck 23 by a Coulomb force or a Johnsen-Rahbek force caused by the electric field.

Further, mounted on a horizontal portion of the stepped portion of the electrostatic chuck 23 is a focus ring 25 that surrounds the wafer W attracted and held thereonto. The focus ring 25 is made of, for example, silicon (Si) or silicon carbide (SiC).

Provided within the susceptor 12 is, by way of example, an annular coolant path 26 extended in a circumferential direction of the susceptor 12. A low temperature coolant such as cooling water or Galden (registered trademark) is circulated through and supplied to the coolant path 26 from a chiller unit (not illustrated) through a coolant line 27. The susceptor 12 cooled by the coolant cools the wafer W and the focus ring 25 via the electrostatic chuck (ESC) 23.

A multiple number of heat transfer gas supply holes are opened to an area (hereinafter, referred to as “attraction surface”) of the electrostatic chuck 23 where the wafer W is attracted and held. The heat transfer gas supply holes 28 are connected with a heat transfer gas supply unit (not illustrated) via a heat transfer gas supply line 29, and the heat transfer gas supply unit supplies a helium (He) gas as a heat transfer gas into a gap between the attraction surface and the rear surface of the wafer W through the heat transfer gas supply holes 28. The He gas supplied into the gap between the attraction surface and the rear surface of the wafer W effectively transfers heat of the wafer W to the electrostatic chuck 23.

A Shower head 30 is provided at a ceiling of the chamber 11 so as to face the susceptor 12 with the processing space S of the processing chamber 15 therebetween. The shower head 30 may include an upper electrode plate 31; a cooling plate 32 that supports the upper electrode plate detachably installed thereto; and a cover body 33 that covers the cooling plate 32. The upper electrode plate 31 is formed of a circular plate-shaped member having a multiple number of gas holes 34 formed through the member in a its thickness direction, and the upper electrode plate 31 is made of a semiconductor such as SiC. Further, a buffer room 35 is formed within the cooling plate 32 and the buffer room 35 is connected with a gas introduction line 36.

The upper electrode plate 31 of the shower head 30 is connected with a DC power supply 37 and a negative DC voltage is applied to the upper electrode plate 31. In this case, the upper electrode plate 31 emits secondary electrons and prevents a decrease in a density of electrons on the wafer W within the processing chamber 15. The emitted secondary electrons flow from the wafer W to a ground electrode (ground ring) 38 made of a semiconductor such as silicon carbide (SiC) or silicon (Si) and provided so as to surround a side surface of the susceptor 12 in the side exhaust path 13.

In the substrate processing apparatus 10 configured as stated above, a processing gas supplied through the processing gas introduction line 36 to the buffer room 35 is introduced into the processing chamber 15 through the gas holes 34 of the upper electrode plate 31 and the introduced processing gas is excited into plasma by the high frequency power (plasma generation power) applied into the processing chamber 15 from the second high frequency power supply 20 via the susceptor 12. Ions in the plasma are attracted toward the wafer W by the high frequency power (bias power) applied to the susceptor 12 from the first high frequency power supply 18 and a plasma etching process is performed on the wafer W.

An operation of each component of the substrate processing apparatus 10 is controlled by a CPU of a controller (not illustrated) included in the substrate processing apparatus 10 according to a program corresponding to a plasma etching process.

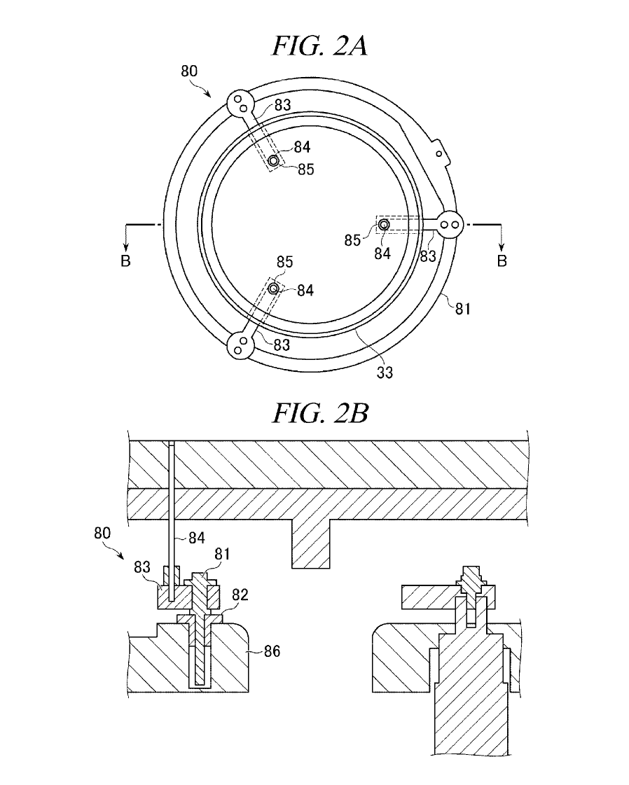

FIG. 2 shows a schematic configuration of a substrate lifting unit included in the susceptor of FIG. 1, and specifically, FIG. 2A is a plane view of this unit when viewed from a direction of an arrow A in FIG. 1 and FIG. 2B is a cross-sectional view taken along a line B-B of FIG. 2A.

Referring to FIGS. 2A and 2B, a substrate lifting unit 80 may include a circular ring-shaped pin holder 81; three lift arms 83 arranged at a same distance in a circumferential direction of the pin holder 81; and three round rod-shaped lift pins 84 to be inserted into lift pin holes of the lift arms 83, respectively.

The pin holder 81 is moved up and down by a straight-line motion converted from a rotation motion of a non-illustrated motor by a ball screw. That is, the pin holder is moved in a vertical direction of FIG. 2B. The ball screw and the motor are provided outside the chamber 11, i.e., on the atmospheric side. Further, the straight-line motion generated by the ball screw and the motor is transferred to a base plate 86 supporting the pin holder 81, and the base plate 86 moves the pin holder 81 up and down.

The lift arms 83 are arm-shaped members, and one ends of the lift arms 83 are connected with the pin holder 81 and the other ends of the lift arms 83 are provided with the lift pin holes that accommodate and support lower ends of the lift pins 84. A diameter of the lift pin hole is greater than that of the lift pin 84 by a predetermined value, and, thus, the lower end of the lift pin 84 is inserted into the lift pin hole in a movable state. That is, the lift pin 84 is mounted on the other end of the lift arms 83. The lift arms 83 are interposed between the pin holder 81 and the lift pins 84 and interlock the pin holder 81 with the lift pins 84. Therefore, as the pin holder 81 moves up and down, the lift arms 83 are moved up and down and move the lift pins 84.

In the substrate lifting unit in accordance with the embodiment of the present disclosure, the lift pin 84 of the substrate lifting unit 80 further has a function of monitoring a temperature of the wafer W supported on a mounting surface.

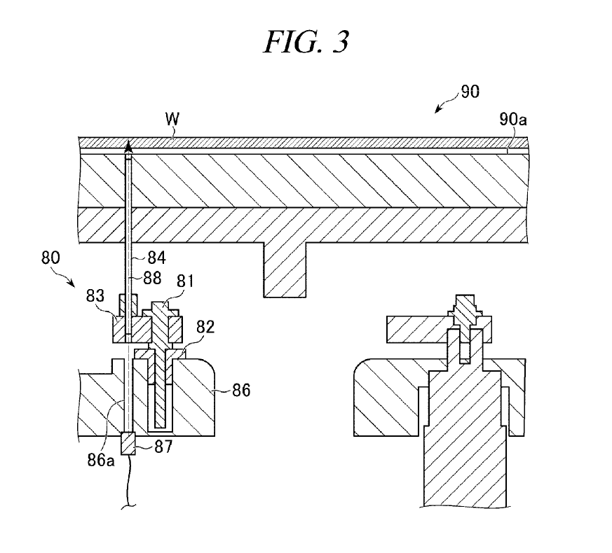

FIG. 3 is a cross-sectional view schematically showing the substrate lifting unit in accordance with the embodiment of the present disclosure.

Referring to FIG. 3, provided on the base plate 86 of the substrate lifting unit 80 is a through hole 86a facing the lower end of the lift pin 84 which is inserted into the lift arm 83 in a movable state. A light irradiating/light receiving unit 87 configured to irradiate a measurement light beam as a low-coherence light beam to the wafer W as a temperature measurement target and receive reflected light beams is fixed at an opening end of the through hole 86a. Here, the opening end of the through hole 86a is different from another opening end facing the lift pin 84.

The light irradiating/light receiving unit 87 serves as a part of a low-coherence light interference temperature measurement system equipped with a light receiving device having a low-coherence light optical system.

Hereinafter, the low-coherence light interference temperature measurement system will be explained.

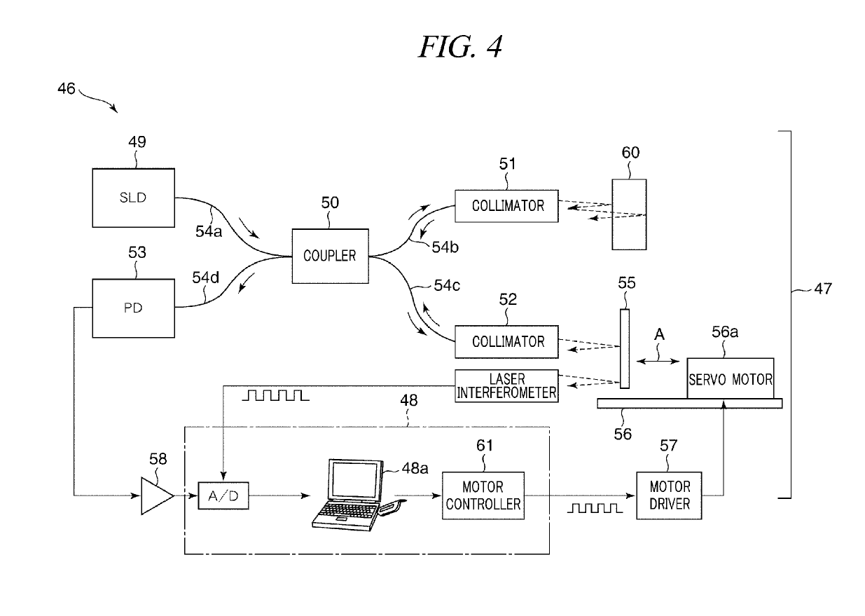

FIG. 4 is a block diagram schematically showing a configuration of a low-coherence light interference temperature measurement system.

Referring to FIG. 4, a low-coherence light interference temperature measurement system 46 may include a low-coherence light optical system 47 that irradiates a low-coherence light beam to a temperature measurement target 60 and receives reflected light beams of the low-coherence light beam; and a temperature calculation device 48 that calculates a temperature of the temperature measurement target 60 based on the reflected light beams received by the low-coherence light optical system 47. The low-coherence light beam refers to light having a short coherence distance (coherence length).

The low-coherence light optical system 47 may include a super luminescent diode (SLD) 49 as a low-coherence light source; an optical fiber coupler 50 (hereinafter, referred to as “coupler”) as a 2×2 splitter connected to the SLD 49; collimators 51 and 52 connected to the optical coupler 50; a photo detector (PD) 53 as a light receiving device connected to the coupler 50; and optical fibers 54a, 54b, 54c and 54d connecting the above-mentioned components.

The SLD 49 irradiates a low-coherence light beam having, for example, a central wavelength of about 1.55 μm or about 1.31 μm and a coherence length of about 50 μm at a maximum output power of about 1.5 mW. The coupler 50 splits the low-coherence light beam from the SLD 49 into two light beams, and these two split low-coherence light beams are transmitted through the optical fibers 54b and 54c to the collimators 51 and 52, respectively. The collimators 51 and irradiate the low-coherence light beams (a measurement light beam 64 and a reference light beam 65 to be described below) split by the coupler 50 to the temperature measurement target 60 and a reference mirror 55, respectively. The PD 53 may include, for example, a Ge photo diode.

The low-coherence light optical system 47 may include the reference mirror 55 positioned in front of the collimator 52; a reference mirror driving stage 56 that horizontally moves the reference mirror 55 by a servomotor 56a in an irradiation direction of the low-coherence light beam from the collimator 52; a motor driver 57 that drives the servomotor 56a of the reference mirror driving stage 56; and an amplifier 58 connected with the PD 53 to amplify an output signal of the PD 53. The reference mirror 55 may include, by way of example, a corner cube prism or a planar mirror having a reflection surface.

The collimator 51 is positioned to face a front surface of the temperature measurement target 60. The collimator 51 irradiates a measurement light beam (measurement light beam 64 to be described below) of the two low-coherence light beams split by the coupler 50 toward the front surface of the temperature measurement target 60 and receives reflected light beams (reflected light beam 66a and reflected light beam 66b to be described below) from the front surface and a rear surface of the temperature measurement target 60 and transmits the reflected light beams to the PD 53.

The collimator 52 irradiates a reference light beam (reference light beam 65 to be described below) of the two low-coherence light beams split by the optical fiber coupler 50 toward the reference mirror 55 and receives a reflected light beam (reflected light beam 68 to be described below) of the low-coherence light beam from the reference mirror 55 and transmits the reflected light beam to the PD 53.

The reference mirror driving stage 56 horizontally moves the reference mirror 55 in a direction indicated by an arrow A in FIG. 4 such that a reflection surface of the reference mirror 55 is kept perpendicular to the light beam irradiated from the collimator 52. Thus, the reference mirror 55 can be moved in a direction indicated by the arrow A (i.e., in an irradiation direction of the low-coherence light beam from the collimator 52).

The temperature calculation device 48 may include a personal computer (hereinafter, referred to as “PC”) 48a that overall controls the temperature calculation device 48; a motor controller 61 that controls, via the motor driver 57, the servomotor 56a moving the reference mirror 55; and an A/D converter that performs an analogue-to-digital conversion while synchronizing an output signal of the PD 53 input to the A/D converter via the amplifier 58 of the low-coherence light optical system 47 with a control signal (driving pulse, for example) output from the motor controller 61 to the motor driver 57. If a distance from the collimator 52 to the reference mirror 55 is accurately measured by a laser interferometer or a linear scale, the A/D converter may perform an analogue-to-digital conversion in synchronization with a control signal depending on a movement distance obtained from the laser interferometer or the linear scale. Accordingly, a thickness of the temperature measurement target 60 can be measured with high accuracy.

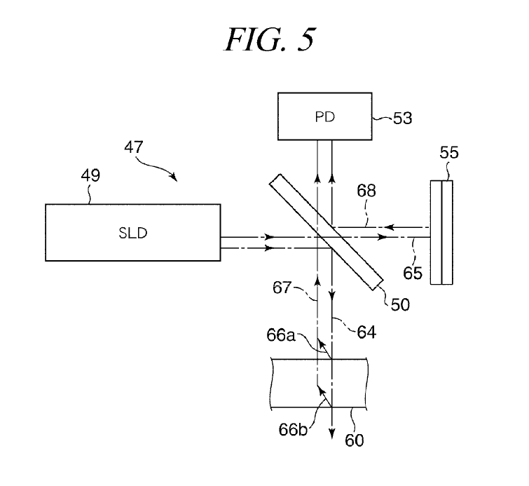

FIG. 5 is an explanatory diagram for describing a temperature measurement operation of the low-coherence light optical system of FIG. 4.

The low-coherence light optical system 47 may employ a Michelson interferometer structure as a basic structure. As depicted in FIG. 5, the low-coherence light beam irradiated from the SLD 49 is split into the measurement light beam 64 and the reference light beam 65 by the coupler 50 serving as a splitter, and the measurement light beam 64 is irradiated toward the temperature measurement target 60 and the reference light beam 65 is irradiated toward the reference mirror 55.

The measurement light beam 64 irradiated onto the temperature measurement target 60 is reflected from both the front surface and the rear surface of the temperature measurement target 60. Both a reflected light beam 66a from the front surface of the temperature measurement target 60 and a reflected light beam 66b from the rear surface of the temperature measurement target 60 are transmitted to the coupler 50 along a same optical path 67. Meanwhile, the reference light beam 65 irradiated onto the reference mirror 55 is reflected from the reflection surface and a reflected light beam 68 from the reflection surface is also transmitted to the coupler 50. Here, as described above, since the reference mirror 55 is horizontally moved in an irradiation direction of the reference light beam, the low-coherence light optical system 47 can change a length of the optical path of the reference light beam 65 and the reflected light beam 68.

In a case that the optical path length of the reference light beam 65 and the reflected light beam 68 is changed by horizontally moving the reference mirror 55, interference occurs between the reflected light beam 66a and the reflected light beam 68 when an optical path length of the measurement light beam 64 and the reflected light beam 66a is equal to that of the reference light beam 65 and the reflected light beam 68. Further, when the optical path length of the measurement light beam 64 and the reflected light beam 66b is equal to that of the reference light beam and the reflected light beam 68, interference occurs between the reflected light beam 66b and the reflected light beam 68. These interferences are detected by the PD 53. When detecting the interference, the PD 53 outputs an output signal.

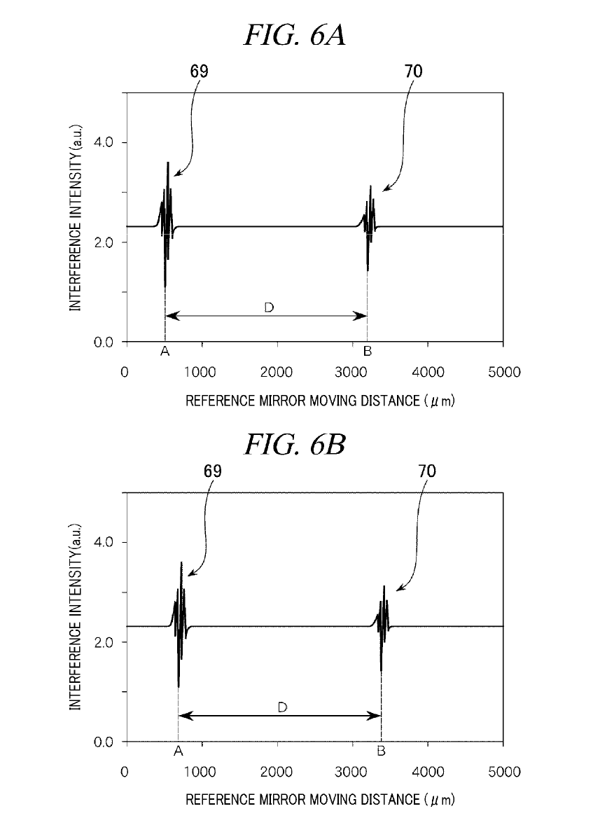

FIGS. 6A and 6B provide graphs each showing interference waveforms detected by a PD of FIG. 4 between the reflected light beams from the temperature measurement target 60 and the reflected light beam from the reference mirror. FIG. 6A shows interference waveforms obtained before a change in a temperature of the temperature measurement target 60 and FIG. 6B shows interference waveforms obtained after a change in a temperature of the temperature measurement target 60. In FIGS. 6A and 6B, the vertical axis indicates an interference intensity and the horizontal axis indicates a horizontal moving distance (hereinafter, simply referred to as “reference mirror moving distance”) of the reference mirror 55 from a predetermined point.

As shown in the graph of FIG. 6A, when the reflected light beam 68 from the reference mirror 55 interferes with the reflected light beam 66a from the front surface of the temperature measurement target 60, an interference waveform 69 having a width of about 80 μm centered at, for example, an interference position A (where an interference intensity has a peak value of about 425 μm) is detected. When the reflected light beam 68 from the reference mirror 55 interferes with the reflected light beam 66b from the rear surface of the temperature measurement target 60, an interference waveform 70 having a width of about 80 μm centered at, for example, an interference position B (where an interference intensity has a peak value of about 3285 μm) is detected. The interference position A corresponds to the optical path length of the measurement light beam 64 and the reflected light beam 66a, and the interference position B corresponds to the optical path length of the measurement light beam 64 and the reflected light beam 66b. Therefore, a difference D between the interference position A and the interference position B corresponds to a difference (hereinafter, simply referred to as “optical path length difference”) between the optical path length of the reflected light beam 66a and that of the reflected light beam 66b. The difference between the optical path length of the reflected light beam 66a and that of the reflected light beam 66b corresponds to an optical thickness of the temperature measurement target 60. Therefore, the difference D between the interference position A and the interference position B corresponds to the optical thickness of the temperature measurement target 60. That is, by detecting the interference between the reflected light beam and the reflected light beam 66a and the interference between the reflected light beam 68 and the reflected light beam 66b, it is possible to measure the optical thickness of the temperature measurement target 60.

If the temperature of the temperature measurement target 60 is changed, the thickness of the temperature measurement target 60 is changed due to thermal expansion (contraction) and a refractive index is also changed, resulting in changes in the optical path length of the measurement light beam 64 and the reflected light beam 66a and the optical path length of the measurement light beam 64 an the reflected light beam 66b. Therefore, after a change in the temperature of the temperature measurement target 60, the optical thickness of the temperature measurement target is changed due to thermal expansion, so that the interference position A of the reflected light beam 68 and the reflected light beam 66a and the interference position B of the reflected light beam 68 and the reflected light beam 66b shift from the interference positions shown in FIG. 6A. To be specific, as shown in the graph of FIG. 6B, the interference position A and the interference position B respectively shift from the interference positions shown in FIG. 6A. Since the interference position A and the interference position B shift depending on the temperature of the temperature measurement target 60, the difference D between the interference position A and the interference position B or the optical path length difference can be calculated, and the temperature of the temperature measurement target 60 can be measured based on the optical path length difference. In addition to a change in the optical thickness of the temperature measurement target 60, positional changes (such as extensions) of various components of the low-coherence light optical system 47 may be a cause for a change in an optical path length.

In the low-coherence light interference temperature measurement system 46, prior to measuring the temperature of the temperature measurement target 60, there is prepared in advance a temperature conversion database that stores temperatures of the temperature measurement target 60 associated with optical path length differences in a memory (not illustrated) included in the PC 48a of the temperature calculation device 48. Here, the temperature conversion database may store a table in which temperatures of the temperature measurement target 60 and optical path length differences are arranged in rows and columns. Accordingly, the memory of the PC 48a may store in advance a regression equation related to a temperature of a wafer W and an optical path difference. When a temperature of the temperature measurement target 60 is measured, the temperature calculation device 48 of the low-coherence light optical system 47 receives an output signal of the PD 53, i.e., a signal indicating the interference position A and the interference position B shown in FIGS. 6A and 6B. Subsequently, the temperature calculation device 48 calculates an optical path length difference based on the received signal and changes the optical path length difference into a corresponding temperature based on the temperature conversion database. Thus, a temperature of the temperature measurement target 60 can be measured.

The light irradiating/light receiving unit 87 shown in FIG. 3 corresponds to the collimator 51 of the low-coherence light optical system 47 in the above-described low-coherence light interference temperature measurement system. In a substrate mounting table 90 equipped with the substrate lifting unit having the light irradiating/light receiving unit 87, a temperature of the wafer W mounted on a substrate mounting surface 90a is measured as described below.

By way of example, with respect to a wafer W made of silicon (Si), there is prepared a temperature conversion database that stores temperatures of the wafer W associated with optical path length differences of reflected light beams, and this database is stored in advance in the memory of the temperature calculation device 48 of the low-coherence light interference temperature measurement system 46.

Then, a measurement light beam 88 as a low-coherence light beam is irradiated from the light irradiating/light receiving unit 87 to the wafer W through the lift pin as an optical path (see FIG. 3). Thereafter, the light irradiating/light receiving unit 87 receives a reflected light beam of the measurement light beam 88 reflected from a front surface of the wafer W and a reflected light beam of the measurement light beam 88 passing through the wafer W and reflected from a rear surface of the wafer W.

Subsequently, the two reflected light beams are transmitted to the coupler 50 and the PD 53 of the low-coherence light interference temperature measurement system through optical fibers, and an optical path length difference is calculated by the temperature calculation device 48 based on an output signal of the PD 53. Based on this optical path length difference, a temperature of the wafer W is measured.

In accordance with the present embodiment, the lift pin 84 of the substrate lifting unit 80 is used as an optical path of the measurement light beam and the reflected light beams. Therefore, a through hole for measuring a temperature of the wafer W need not be formed in the substrate mounting table 90, so that it is possible to prevent a deterioration of temperature uniformity in the mounting table caused by the through hole and also possible to accurately measure a temperature of the wafer W.

In accordance with the present embodiment, fluorescent paint as in the conventional technique need not be used, and, thus, the inside of the chamber is not contaminated. Further, a temperature of the wafer W can be measured without bringing the lift pin 84 into contact with the wafer W, and, thus, it is possible to avoid generation of a hot spot, and a wafer for temperature monitor is not needed, so that a temperature of the wafer W can be measured during a process. Furthermore, since the measurement is performed by a non-contact mode, contact thermal resistance does not cause a decrease in measurement accuracy and a temperature of the wafer W can be accurately measured.

In accordance with the present embodiment, the light irradiating/receiving unit 87 and the lift pin 84 serving as an optical path are configured as one body, and, thus, the measurement light beam and the reflected light beams do not fluctuate, resulting in further improvement in measurement accuracy.

In the present embodiment, at least one of a multiple number of, e.g., three, lift pins is used as the lift pin 84 serving as an optical path of the low-coherence light beam for temperature measurement of the wafer W.

In the present embodiment, the lift pin 84 serving as an optical path of the measurement light beam and the reflected light beams may include a rod pin or a hollow pin.

In case the lift pin 84 is the rod pin, desirably, the lift pin 84 may be made of a material, such as sapphire or quartz, capable of transmitting a low-coherence light beam. Both end surfaces of the lift pin 84 are parallel to each other and mirror-polished in order to prevent diffusion of the transmitted measurement light beam or reflected light beams. In this case, in the front end surface facing the wafer W, only a portion of less than about 1 mmΦ of an area from which a measurement light beam is emitted needs to be parallel to the other end surface. Accordingly, by positioning this portion of the irradiation area to be parallel to the wafer W, the measurement light beam can be perpendicularly incident on the surface of the wafer W.

In case the lift pin 84 is the hollow pin, the measurement light beam and the reflected light beams are transmitted through the hollow. Therefore, a material of the lift pin 84 is not particularly limited as long as it can serve as a lift pin. Desirably, a diameter of the hollow may be, for example, 3 mmΦ or less. Unlike the rod pin, both end surfaces of the hollow pin need not be parallel to each other because an optical path axis of the lift pin is not changed on an input surface or output surface of the light beam. In case of the hollow lift pin, if a temperature measurement target is placed in a vacuum atmosphere or in a depressurized atmosphere having a less pressure than an atmospheric atmosphere, there are provided a partition wall for blocking the hollow of the lift pin at a position, for example, at an opposite end of the front end. A glass plate having a thickness in the range of, for example, from about 0.5 mm to about 1.0 mm can be used as the partition wall. Further, the hollow pin may include a Brewster window at its front end.

In the present embodiment, based on a temperature measurement result of the wafer W measured by a low-coherence light interference thermometer using the lift pin as an optical path, a temperature of a chiller circulating the coolant path 26 and a pressure of the heat transfer gas supplied between the attraction surface of the electrostatic chuck 23 and the rear surface of the wafer W are controlled to control a temperature of the wafer W.

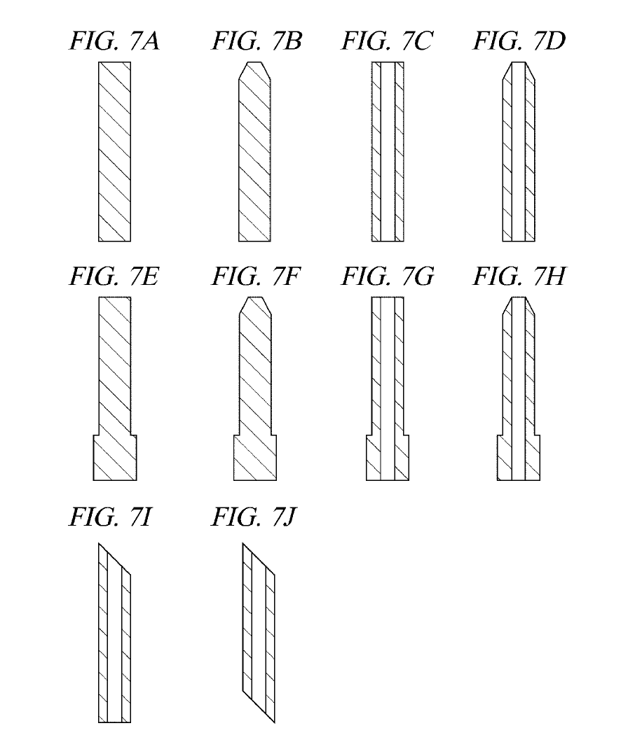

FIGS. 7A to 7J provide cross-sectional views each showing an example lift pin employed in the substrate mounting table in accordance with the present embodiment.

FIG. 7A shows a rod pin serving as a lift pin and the rod pin is made of a material, such as sapphire, capable of transmitting a low-coherence light beam and formed in a cylinder shape having a uniform outer diameter. Both end surfaces of the rod pin are parallel to each other and mirror-polished. Since both end surfaces of this lift pin are parallel to each other and mirror-polished, it is possible to irradiate a measurement light beam perpendicularly to the front surface of the wafer W and receive a reflected light beam in a good manner.

FIG. 7B also shows a rod pin as a lift pin and the rod pin is made of a material, such as sapphire, capable of transmitting a low-coherence light beam and formed into a cylinder shape. Both end surfaces of the rod pin are parallel to each other and mirror-polished. However, a front end of the rod pin is formed in a taper shape to be thinner than the other end. With this lift pin, it is possible to irradiate a measurement light beam perpendicularly to the front surface of the wafer W and receive a reflected light beam in a good manner.

FIG. 7C shows a hollow pin as a lift pin and the hollow pin has a hollow cylinder. Both end surfaces of the hollow pin are parallel to each other. In the hollow pin, a light beam passes through a hollow, and, thus, the hollow pin may not be made of a material capable of transmitting a low-coherence light beam. This lift pin may be made of, for example, quartz, sapphire, ceramic or resin. With this lift pin, it is also possible to irradiate a measurement light beam perpendicularly to the front surface of the wafer W through a hollow optical path and receive a reflected light beam in a good manner.

FIG. 7D shows a hollow pin as a lift pin and the hollow pin has a hollow cylinder. Both end surfaces of the hollow pin are parallel to each other. However, a front end of the hollow pin is formed in a taper shape to be thinner than the other end. This lift pin may not be made of a material capable of transmitting a low-coherence light beam and may be made of, for example, quartz, sapphire, ceramic or resin. With this lift pin, it is also possible to irradiate a measurement light beam perpendicularly to the front surface of the wafer W and receive a reflected light beam in a good manner.

FIG. 7E shows a rod pin as a lift pin, and this lift pin is different from the lift pin shown in FIG. 7A in that a diameter of a front end of the lift pin is greater than a diameter of the other end thereof. Since both end surfaces of the lift pin are parallel to each other and mirror-polished, it is possible to irradiate a measurement light beam perpendicularly to the front surface of the wafer W and receive a reflected light beam in a good manner with this lift pin.

FIG. 7F shows a rod pin as a lift pin, and this lift pin is different from the lift pin shown in FIG. 7E in that a front end of the lift pin is formed in a taper shape to be thin. Since both end surfaces of the lift pin are parallel to each other and mirror-polished, it is possible to irradiate a measurement light beam perpendicularly to the front surface of the wafer W and receive a reflected light beam in a good manner with this lift pin. Further, since there is no restriction in incline angle of the front end of this lift pin, it becomes easy to fabricate this lift pin with low process tolerance, and since a contact area with the rear surface of the wafer W may be a dot, it is possible to suppress dust from adhering to the wafer corresponding to a position of the lift pin.

FIG. 7G shows a hollow pin as a lift pin, and this lift pin is different from the lift pin shown in FIG. 7C in that a diameter of a front end of the lift pin is greater than an outer diameter of the other end thereof. With this lift pin, it is also possible to irradiate a measurement light beam perpendicularly to the front surface of the wafer W along a hollow optical path and receive a reflected light beam in a good manner.

FIG. 7H shows a hollow pin as a lift pin, and this lift pin is different from the lift pin shown in FIG. 7D in that an outer diameter of a front end of the lift pin is greater than an outer diameter of the other end thereof. With this lift pin, it is also possible to irradiate a measurement light beam perpendicularly to the front surface of the wafer W and receive a reflected light beam in a good manner.

FIG. 7I shows a hollow pin as a lift pin, and this lift pin is different from the lift pin shown in FIG. 7C in that a front end surface of the lift pin inclines with respect to an optical path axis. Since this lift pin is a hollow pin, a light-emitting surface need not be parallel to a temperature measurement target. With this lift pin, it is also possible to irradiate a measurement light beam perpendicularly to the front surface of the wafer W and receive a reflected light beam in a good manner.

FIG. 7J shows a hollow pin as a lift pin, and this lift pin is different from the lift pin shown in FIG. 7I in that both end surfaces of the lift pin incline with respect to an optical path axis. Since this lift pin is a hollow pin, both end surfaces need not be parallel to a temperature measurement target. With this lift pin, it is also possible to irradiate a measurement light beam perpendicularly to the front surface of the wafer W and receive a reflected light beam in a good manner.

Hereinafter, the substrate lifting unit in accordance with modification examples will be explained.

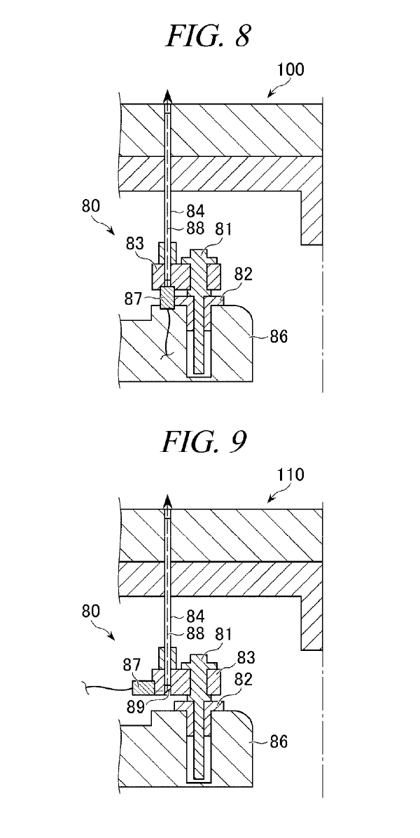

FIG. 8 is a cross-sectional view schematically showing a configuration of the substrate lifting unit in accordance with a first modification example.

Referring to FIG. 8, the substrate lifting unit of the first modification example is different from the substrate lifting unit 80 shown in FIG. 3 in that a light irradiating/receiving unit 87 is provided at a lift arm 83. In the first modification embodiment, a measurement light beam 88 may be irradiated to a wafer W (not illustrated) along a straight-line optical path.

In accordance with the first modification example, a gap between the light irradiating/receiving unit 87 and the lift pin 84 is narrow, resulting in a sufficient decrease in possibility of separation of an optical axis. Therefore, it is possible to accurately measure a temperature.

FIG. 9 is a cross-sectional view schematically showing a configuration of the substrate lifting unit in accordance with a second modification example.

Referring to FIG. 9, the substrate lifting unit of the second modification example is different from the substrate lifting unit shown in FIG. 8 in that a light irradiating/receiving unit 87 is installed to a lift arm 83 so as to be perpendicular to a lift pin 84 and a measurement light beam 88 is reflected from a mirror 89 and irradiated to a wafer W along a bent optical path.

In accordance with the second modification example, when the light irradiating/receiving unit 87 is installed to a lift arm 83, flexibility of a layout can be increased.

In the second modification example, a prism may be used instead of the mirror 89 with the same effect.

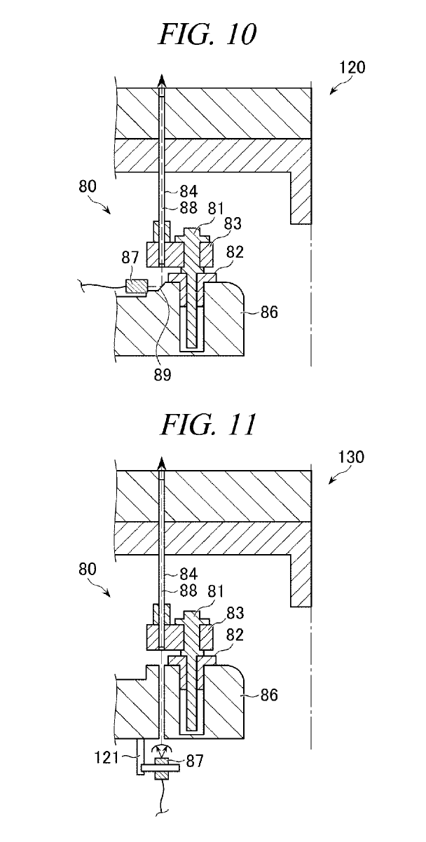

FIG. 10 is a cross-sectional view schematically showing a configuration of the substrate lifting unit in accordance with a third modification example.

Referring to FIG. 10, the substrate lifting unit of the third modification example is different from the substrate lifting unit shown in FIG. 9 in that a light irradiating/receiving unit 87 is installed to a base plate and a measurement light beam 88 is reflected from a mirror 89 and irradiated to a wafer W along a bent optical path.

In accordance with the third modification example, when the light irradiating/receiving unit 87 is installed to the base plate 86, flexibility of a layout can be increased.

In the second modification example, a prism may be used instead of the mirror 89 with the same effect.

FIG. 11 is a cross-sectional view schematically showing a configuration of the substrate lifting unit in accordance with a fourth modification example.

Referring to FIG. 11, the substrate lifting unit of the fourth modification example is different from the substrate lifting unit 80 shown in FIG. 3 in that a light irradiating/receiving unit 87 is installed to a base plate via a support member 121. Provided at a fixing unit between the light irradiating/receiving unit 87 and the support member 121 is an adjustment unit (not illustrated) capable of adjusting an irradiation angle of a measurement light beam irradiated from the light irradiating/receiving unit 87. By way of example, the adjustment unit of the irradiation angle controls an angle in a state that the light irradiating/receiving unit 87 is equipped with the holder having an incline angle control unit, so that an irradiation angle of the measurement light beam may be adjusted automatically or manually. In the fourth modification example, a measurement light beam 88 is irradiated to a wafer W along a straight-line optical path.

In accordance with the fourth modification example, since an irradiation angle of the measurement light beam can be changed, when an optical axis of a measurement light beam is deviated from a lift pin 84 serving as an optical path, it is possible to rapidly and finely control the optical axis to be brought into the optical path.

There have been provided some embodiments to explain the present disclosure, but it is not limited to the above-described embodiments.

As described above, in each embodiment, a substrate on which a plasma process is performed is not limited to a wafer for a semiconductor device, and may include various substrates used for a flat panel display (FPD) including a liquid crystal display (LCD), or a photomask, a CD substrate, a print substrate, or the like.

What is claimed is:

1. A substrate mounting table comprising:
a mounting surface configured to mount a substrate thereon;
a substrate lifting unit configured to lift the substrate by a lift pin from the mounting surface; and
a light irradiating/receiving unit configured to irradiate a measurement light beam as a low-coherence light beam to the substrate through an inside of the lift pin serving as an optical path and receive reflected light beams from a front surface and a rear surface of the substrate.

2. The substrate mounting table of claim 1, wherein the light irradiating/receiving unit is fixed to a base plate of the substrate lifting unit and the measurement light beam is irradiated to the substrate along a straight-line optical path.

3. The substrate mounting table of claim 1, wherein the light irradiating/receiving unit is fixed to a lift arm of the substrate lifting unit and the measurement light beam is irradiated to the substrate along a straight-line optical path.

4. The substrate mounting table of claim 1, wherein the light irradiating/receiving unit is fixed to a base plate of the substrate lifting unit and the measurement light beam is reflected from a prism or a mirror and irradiated to the substrate along a bent optical path.

5. The substrate mounting table of claim 1, wherein the light irradiating/receiving unit is fixed to a lift arm of the substrate lifting unit and the measurement light beam is reflected from a prism or a mirror and irradiated to the substrate along a bent optical path.

6. The substrate mounting table of claim 2, wherein the light irradiating/receiving unit includes an adjustment unit capable of adjusting an irradiation angle of the measurement light beam.

7. The substrate mounting table of claim 1, wherein the light irradiating/receiving unit is optically connected to a light receiving device as a low-coherence light optical system included in a low-coherence light interference temperature measurement system.

8. The substrate mounting table of claim 1, wherein the lift pin includes a rod pin.

9. The substrate mounting table of claim 8, wherein a low-coherence light beam passes through the rod pin and both end surfaces of the rod pin are parallel to each other and mirror-polished.

10. The substrate mounting table of claim 9, wherein an area of a front end surface of the rod pin from which the measurement light beam is emitted is parallel to the other end surface facing the front end surface.

11. The substrate mounting table of claim 1, wherein the lift pin includes a hollow pin.
